(19) United States
(12) Patent Application Publication
(10) Pub. No.: US 2026/0061631 A1
(43) Pub. Date: Mar. 5, 2026

(54) Programmable Micro-Stamp Pick-and-Place Apparatus and Method

(71) Applicant: National University of Singapore, Singapore (SG)

(72) Inventors: Aaron Voon-Yew THEAN, Singapore (SG); Baochang XU, Singapore (SG); Yu ZHANG, Singapore (SG)

(21) Appl. No.: 19/318,838

(22) Filed: Sep. 4, 2025

(30) Foreign Application Priority Data
Sep. 4, 2024 (SG) 10202402742P

(51) Int. Cl. B25J 15/00; B29D 99/00; B29K 21/00; B33Y 80/00

(52) U.S. Cl. CPC B25J 15/008; B25J 15/0023; B29D 99/005; B33Y 80/00; B29K 2021/00

(57) ABSTRACT

The present invention describes an innovative programmable micro-stamp pick and place apparatus and method. This invention provides a micro-stamp device having a patterned polymer membrane that is configured with micropillars. When a micro-stamp device, singly or arranged in an array or group, is inflated with a fluid, the patterned polymer membrane deforms from a planar state and this causes the micropillars to peel from the workpiece. This patterned polymer membrane can thus be used to pick and place electronic die(s) or chip(s), single or in an array or a group, during fabrication, or to pick and replace defective die(s) or chip(s) during a test and repair process.

### CROSS-REFERENCE TO RELATED APPLICATIONS

The present invention claims priority to Singapore patent application no. 10202402742P filed on 4 Sep. 2024, the contents of which are incorporated by reference in their entirety.

### TECHNICAL FIELD

The present invention relates to low-cost, programmable micro-stamp pick-and-place apparatus and method that are enabled by actuating a micro-stamp device or micro-stamp devices arranged in an array or pattern. The micro-stamp device is provided to handle electronic dies or chips of different materials, sizes and thicknesses in a single move, singly or in an array and conforming to a substrate surface. This method is configured for semiconductor fabrication and/or to replace defective die(s) or chip(s) located on a substrate.

### BACKGROUND

Augmented reality (AR) devices require ultrahigh-brightness micro-LED for display, photonic arrays for massive data transmission, memories, AI-powered processors, sensors and MEMS for sensing, computing, and actuating. All those components need to be integrated on conformable or flexible substrates for these AR devices to be incorporated into wearable electronic products. High precision pick-and-place technology is needed to assemble multiple devices at both the chiplet and wafer levels. At the same time, the packaging of photonic integrated chips and 3D-IC chiplet needs to assemble electronic dies made from multiple substrate materials with different sizes and thicknesses into one electronic system in a 3D manner. Conventional pick-and-place tool using vacuum nozzles is limited to transferring rigid dies with sizes larger than substantially 100 μm and those having flat or smooth surfaces.

Micro-stamp transfer printing (MTP) technology is the key enabler for heterogenous integration of these electronic dies and chips on different substrates. Conventionally, several MTP techniques have been implemented to transfer tens or hundreds of components in one pick-and-place cycle; these MTP techniques include using elastomeric micro-stamp pick-and-place; laser assisted elastomeric stamping and laser beam adhesive cleavage; and electromagnetic stamping transfer. In one approach, X-Celeprint is using elastomeric stamps to transfer photonic and LED dies onto multiple substrates. However, several limitations of this method restrain its expansion to wider applications; for example, an elastomeric stamp needs to be customerized based on the die material, size and pitch layout. The elastomeric stamp needs to be refabricated and replaced if any one of the parameters, such as die size, thickness or pitch, has changed; this leads to incurring high micro-stamp fabrication cost. In another approach, Applied Materials, Inc. uses laser beam assisted elastomeric stamping and laser beam adhesive cleavage to release dies onto a target substrate; however, this laser method generates organic contaminations on dies, and causes issues in the subsequent interconnect and device fabrications. In yet another approach, Apple Inc. is using an electromagnetic method to conduct die transfer, but this suffers from a low yield issue, such as, die-missing and electro-static discharging. Among all these methods, removing a single malfunctioned die or a misaligned die and replacing with them with a good performing die is a huge challenge. Therefore, there is a need to provide a versatile, low-cost, clean and programmable MTP technology to overcome the above-known limitations.

### SUMMARY

The following presents a simplified summary to provide a basic understanding of the present invention. This summary is not an extensive overview of the present invention, and is not intended to identify key features of the invention. Rather, it is to present some of the inventive concepts of this invention in a generalised form as a prelude to the detailed description that is to follow.

The present invention seeks to provide a programmable micro-stamp pick and place apparatus and method in the MTP technology. The innovative pick and place apparatus and method aim to overcome the limitations of conventional MTP and provides desirable advantages and improvements.

In one embodiment, the present invention provides a programmable micro-stamp pick and place apparatus according to the appended claims.

In another embodiment, the present invention provides a programmable micro-stamp pick and place method according to the appended claims.

### BRIEF DESCRIPTION OF THE DRAWINGS

This invention will be described by way of non-limiting embodiments of the present invention, with reference to the accompanying drawings, in which:

FIG. 1 illustrates a schematic of a programmable micro-stamp pick-and-place apparatus according to an embodiment of the present invention, whilst FIG. 2 illustrates a prototype of the apparatus shown in FIG. 1;

FIG. 3 illustrates a structure of the micro-stamp device employed in the apparatus shown in FIG. 1;

FIG. 4 illustrates a structure of the micro-stamp device shown in FIG. 3 in a deflated state; whilst FIG. 5 illustrates the structure of the micro-stamp device in an inflated state;

FIG. 6 illustrates a perspective view of the micro-stamp device, whilst FIG. 6A illustrates an enlarged view of the micropillars;

FIG. 7 illustrates a perspective view of the micro-stamp device in the deflated state; whilst FIG. 7A illustrates that in the inflated state;

FIG. 8 illustrates a plurality of micro-stamp devices that are interconnected to form an array or pattern according to one embodiment;

FIGS. 9 to 12 illustrate progression of the above micro-stamp device being lowered down onto a substrate, picking and placing the substrate, and retracting to its home position in the method of use.

### DETAILED DESCRIPTION

One or more specific and alternative embodiments of the present invention will now be described with reference to the attached drawings. It shall be apparent to one skilled in the art, however, that this invention may be practised without such specific details. Some of the details may not be described at length so as not to obscure the invention.

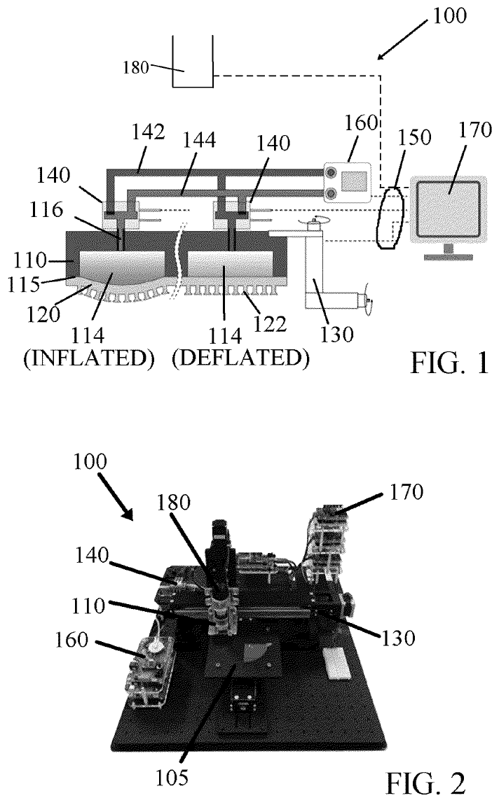

FIG. 1 shows a schematic of a programmable micro-stamp pick-and-place apparatus 100 and method 200 according to an embodiment of the present invention. As shown in FIG. 1, the micro-stamp pick-and-place apparatus 100 is made up of a micro-stamp device 110 that is operable to translate and/or rotate by an XYZ stage 130; an interior cavity 114 of each of the micro-stamp device 110 is fluidly connected to a fluid control valve 140 and a micro fluid pump 160. A controller 170 is provided to control the micro fluid pump 160, all the fluid control valves 140 and the XYZ stage 130 with aid of a camera 180 via some input, output and control signals 150. FIG. 2 shows a prototype of the above apparatus 100 that was configured to test the method 200.

FIG. 3 shows a structure of the micro-stamp device 100 according to one embodiment. As seen from FIG. 3, the micro-stamp device 100 is made up of a micro-stamp body 112 having an open interior cavity 114 with a mouth 115 that is substantially planar. For a simple illustration, the micro-stamp body 112 is shown with two open interior cavities 114 with the mouth 115 at a front face and a fluid channel 116 located at an opposite rear face. Each of the fluid channel 116 is fluidly connected to a fluid valve 140, whilst the front face is bonded to a patterned polymer membrane 120. In one embodiment, a first mold is formed by 3D printing and a silicone polymer (such as, PDMS) is casted in the first 3D printed mold to produce the micro-stamp body 112, whilst a second mold is fabricated by a photolithograph method and a silicone polymer solution (such as, PDMS or Ecoflex 50) is spin-coated in the second mold to produce the patterned polymer membrane 120 with micropillars 122. The patterned polymer membrane 120 thus produced is then bonded to the front face of the micro-stamp body 112 to produce the micro-stamp device 110. In an alternative embodiment, it is possible to directly 3D print the micro-stamp body 112.

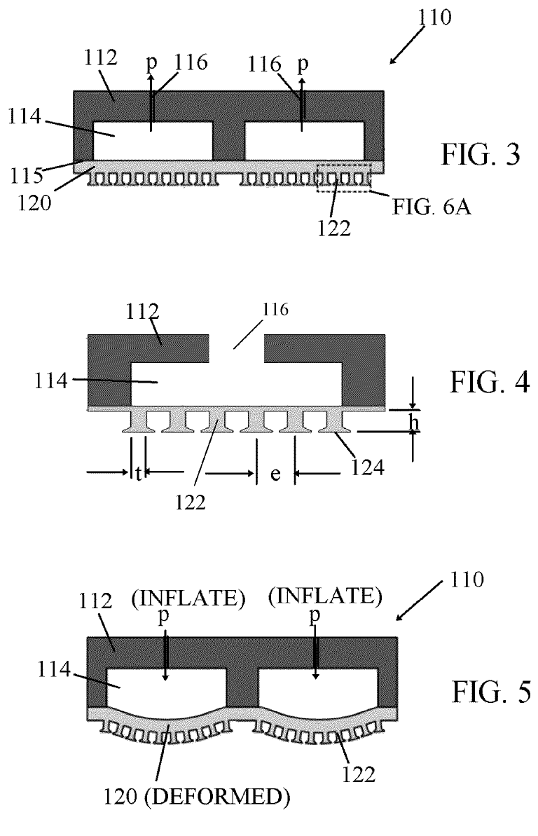

In one embodiment, the patterned polymer membrane 120 and the micropillars 122 are made from a silicon having a hardness of substantially 40-45 Shore A. As shown in FIG. 4, each of the micropillars 122 extends from the membrane 120 with a height h and a thickness t of substantially 10 μm, and a pitch e of substantially 20 to 30 μm. This means that the micropillars 122 have a density of substantially 1000 to 2500 micropillars/mm², but is not so restricted. When the interior cavity 114 of the micro-stamp device 110 is not pressurized, that is in a deflated state, the tips 124 of the micropillars 122 are substantially planar or flat. When the interior cavity 114 is pressurized or inflated, the patterned polymer membrane 120 bulges or bends out in a convex manner, as seen in FIG. 5, whilst the micro-stamp body 112 having a thicker body maintains its shape and dimensions. In this way, when the micro-stamp device 110 in its deflated or non-activated state is moved to contact an electronic die or chip as the workpiece W, the tips 124 of the micropillars 122 contact the workpiece W in a pick location; when the cavity 114 of the micro-stamp device 110 is inflated, the patterned polymer membrane 120 bulges out and in the bulge deforming or flexing process, the tips 124 of the micropillars 122 are progressively peeled from the workpiece W in a place location. In this way, by controlling deflation and inflation of the micro-stamp device 110, it can be used to pick-and-place minute workpieces W, such as a semiconductor product at both the chip or die level. From testing of the above apparatus 100, it was found that with the soft micropillars 122 of 40-45 Shore A, the viscoelastic adhesion force generated at the semiconductor chip or die surface is substantially 20 to 1400 mN/mm² which is sufficient to overcome the dynamic forces on the workpiece W as the XYZ stage 130 is operated.

As seen from FIG. 3 or 4, the tip 124 of each of the micropillars 122 is shown to terminate with an expanded tip having a substantially flat end face. In another embodiment, it is possible that the tip 124 terminates with a simple square end having a flat end face.

During testing of the micro-stamps 110, it was found that the workpiece W is not confined to have a planar surface, meaning workpieces with arcuate surfaces can also be picked and placed with the micro-stamps 110 of the present invention. Due to the softness of the patterned polymer membrane 120 and the micropillars 122, the tips 124 of the micropillars is conformal or adaptable to a curved or arcuate surface of a workpiece W or substrate S which is present on an integrated circuit board for a wearable electronic gadget.

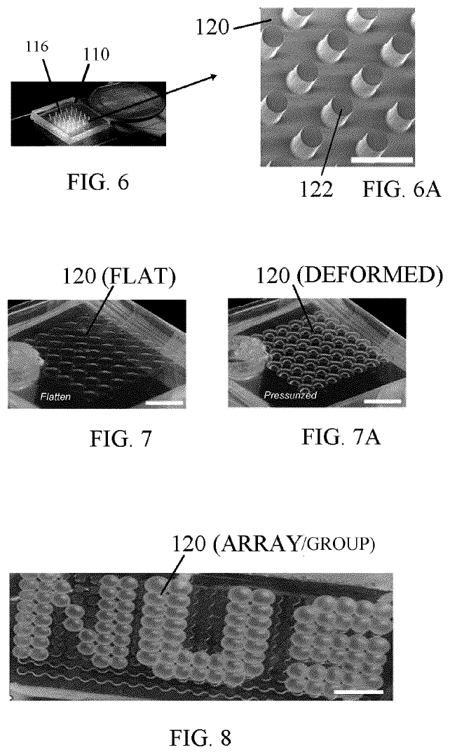

FIG. 6 shows a top perspective view of an array of micro-stamps 110, whilst FIG. 6A shows an electron micrograph of the micropillars 122 in the deflated state. FIG. 7 shows a bottom perspective view of an array of micro-stamps 110 that are fluidly interconnected and in the deflated state, whilst FIG. 7A shows the array/group of interconnected micro-stamps 110 being inflated by actuating a single fluid control valve 140.

In FIGS. 1, 3 and 5, the micro-stamp devices 110 are shown with each interior cavity 114 being fluidly connected to an associated fluid channel 116; however, in another embodiment, it is possible that a plurality of micro-stamp devices are fluidly interconnected to form a pattern, an array or a group arrangement, as is seen in FIG. 8, which can be reprogrammed at the controller 170. FIG. 8 shows an array/group of micro-stamp devices 110 arranged in a pattern of NUS being fluidly interconnected and inflated through a single fluid control valve 140. This embodiment is useful, for eg. when programming the micro-stamps 110 to select and to place RGB dies on a substrate S in the manufacture of a high-density colour display, or to select, pick and replace any defective RGB die(s) (individually or in an array/group) from a substrate during test and repair of a high-density colour display. This embodiment is also useful in that it overcomes X-Celeprint's elastomeric stamps which are limited by the following conventional features:
a) Controlled by customized or specific design parameters once the elastomeric stamps are fabricated;
b) inability to be configured for picking and placing dies or chips on curved, arcuate or flexible substrate;
c) inability to reprogram picking and placing of die(s) or chip(s) in any pattern, array or group once the conventional elastomeric stamps are fabricated, whereas in the present invention, the micro-stamps 110 can be flexibly reprogramed to any pattern(s), array(s) or group(s) by software update at the controller 170; and
d) inability to reprogram picking and replacing defective die(s) or chip(s) in any pattern, array or group once the conventional elastomeric stamps are fabricated, whereas in the present invention, the micro-stamps 110 can be easily and flexibly reprogrammed to any pattern(s), array(s) or group(s) by software update at the controller 170.
   The micro-stamp devices 110 of the present invention overcome these limitations and offer a useful, valuable and effective solution to die or chip placement or repair, which leads to cost savings. The micro-stamp devices 110 of the present invention also overcomes the disadvantages of using Advanced Materials' high temperature laser process and Apple's electro-static discharge process.

As the micro-stamps can be fluidly interconnected according to a pattern, array or group required in an application, it is now possible for the above programmable pick-and-place apparatus 100 to be configured to pick and place multiple die sizes and thicknesses or dies in different patterns onto a substrate in a single move. This feature and method are not possible or provided by the conventional MTP technology; this feature and method also lead to lowering micro-stamp fabrication costs, and providing a lower cost MTP technology and lower operating cost due to use of smaller bills of materials (BoMs). This innovative MTP technology retains its fast electronic response from the controller 170, the micro fluidic pump 160 and the micro fluid control valves 140.

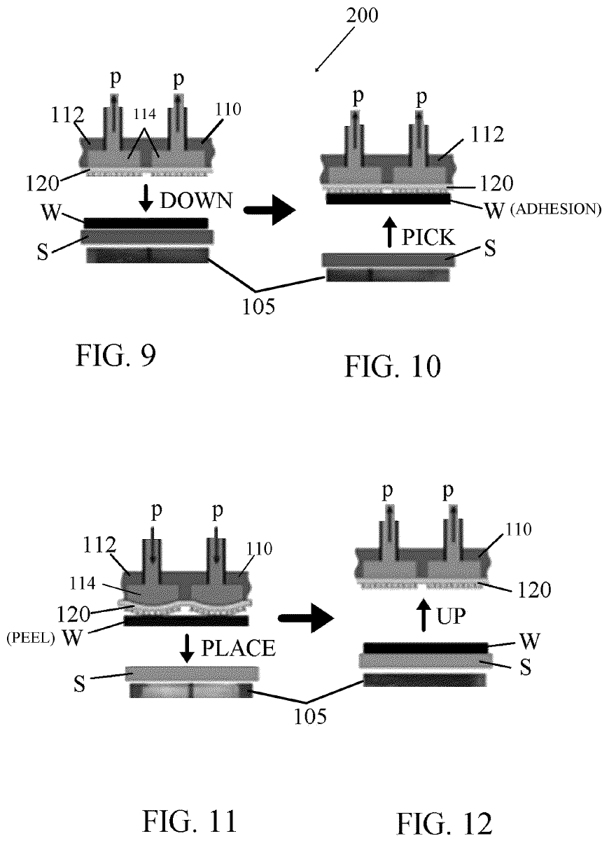

Now moving to the use of the above programmable micro-stamp pick and place method 200. FIG. 9 shows the micro-stamp device 110 is moved down according to some command signals 150 from the controller 170 to contact a workpiece W (which may be a die or chip) on a support substrate S (or a tray), that is supported on a work-table 105. Due to higher adhesion force between the deflated state of the micro-stamp device 110 and the workpiece W than between the workpiece W and the support substrate S, the workpiece W is picked up and adhered on the patterned polymer membrane 120. The micro-stamp device 110 is then moved to a desired placing location as commanded through the controller 170, and the workpiece W is placed on the receiving substrate S, as seen in FIG. 11. Then the cavity 114 of the micro-stamp device 110 is inflated, resulting in the patterned polymer membrane 120 bulging out and in the bulge deforming process, the tips 124 of the micropillars 122 are progressively peeled from the workpiece W. The Van der Waals forces between the workpiece W and receiving substrate S will take control and keep the workpiece at the desired placement location. Once the place function has been executed, the micro-stamp device 110 is moved back to its home position or a next programmed pick location, as seen in FIG. 12.

The above innovative programmable micro-stamp pick and place apparatus 100 and method 200 can be used in the following electronic fabrication applications, but they are not so limited by these examples:
Micro LED assembly: In Micro LED manufacturing, the red, green, and blue light dies (RGB dies) are fabricated using different materials. The three-color dies need to be pre-arranged to form RGB groups on one tray before they can be transferred onto a panel in a batch-to-batch manner. The micro-stamp device 110 with micro patterned polymer membrane 120 array can transfer RGB dies batch by batch onto the panel from each red, green and blue die wafer in a sequential manner. The pre-arrangement process step is saved, therefore the process throughput is improved. The gentle press force to the dies has potential to achieve higher yield and low die damage. The attribute of controlling individual micro-stamp device 110 endows the stamp the capability for die repair, a feature and process which conventional MTP technology are unable to provide or handle.
3D-IC or photonic heterogeneous integration: The photonic integrated chip (PIC) possesses various advantages such as low-loss transmission, large bandwidth (multiplexing capability), immunity from electromagnetic interference (EMI), small size and light weight, etc. The packaging of photonic integrated chips and 3D-IC chiplet need to assemble devices made from multiple materials with different sizes and thickness into one system in 3D manner. High precision pick and place technology is needed to assemble multi-material devices at both the chiplet and wafer levels. The micro-stamp device 110 soft transfer printing is preferred due to the fragility of these components. The individual micro-stamp device and micropillar 122 sizes and heights can be modulated by the micro pressure valves 140. This attribute enables this technology to transfer components made from different materials with different thicknesses and sizes on a single micro-stamp device 110. The high micro-stamp cost issue and process productivity are improved dramatically with the use of the present invention.
Large scale 2D materials or nanofilm transfer: The large surface contact area switching ratio between micro-stamp device 110 inflation and deflation states illustrates the potential for handling thin and fragile nano-film transfer, such as large size 2D materials and lithium niobate. The full contact of micro-stamp device 110 with such nano-film can reduce the wrinkle generation and keep the nano-film in a flat mode after peeling off from growth wafer. After being transferred onto a target substrate, inflating the micro-stamp device 110 can significantly reduce the contact area with 2D material during the placing process. The 2D materials will be left on the target substrate due to the higher adhesion force between the 2D film and the target substrate than the viscoelastic adhesion force between the micro-stamp device 110 and the 2D nano-film.

While specific embodiments have been described and illustrated, it is understood that many changes, modifications, variations and combinations of variations disclosed in the text description and drawings thereof could be made to the present invention without departing from the scope of the present invention. For eg., the workpiece W can be a die, a chip, a semiconductor wafer, a packaged semiconductor product or any product that need to be picked-and-placed in a manufacturing, testing or research facility.

We claim:

1. A micro-stamp pick-and-place apparatus comprising:
a micro-stamp body having a hollow micro-cavity;
a flexible polymer membrane formed across a mouth of the hollow micro-cavity;
a plurality of micropillars formed to extend out from the flexible polymer membrane; and
a fluidic channel formed through the micro-stamp body to supply a fluid pressure into the hollow micro-cavity;
wherein, when the fluid pressure is at substantially zero gauge pressure, the flexible polymer membrane and the plurality of micropillars are substantially planar, in an deflated state, so that pressing the plurality of micropillars onto a workpiece causes the workpiece to adhere to the plurality of micropillars in a pick location, and inflating the fluid pressure causes the flexible polymer membrane to deform from a plane of the workpiece, in an inflated state, in order to cause the plurality of micropillars to release or peel from the workpiece in a place location.

2. The apparatus according to claim 1, further comprising a plurality of the micro-stamp bodies, wherein the associated flexible polymer membranes and micropillars are arranged in groups or arrays according to a desired pattern, and separate groups or arrays of the micropillars are operable to pick and place workpieces of separate sizes or thicknesses.

3. The apparatus according to claim 2, wherein each hollow micro-cavity or a group of hollow micro-cavities according to the desired pattern or array of micro-stamp bodies is/are controllable by a fluid control valve fluidly communicating through the fluidic channel located at one of the micro-stamp bodies.

4. The apparatus according to claim 3, further comprising multiple arrays of micro-stamp bodies, with separate hollow micro-cavity or groups of hollow micro-cavities being controllable by separate fluid control valves.

5. The apparatus according to claim 3, further comprising:
a micro pump in fluid communication with the fluid control valve or valves;
an XYZ stage supporting the plurality of micro-stamp bodies; and
a controller operable to control the XYZ stage, the fluid control valves and the micro pump.

6. The apparatus according to claim 1, wherein a 3D printed mold is used to cast the micro-stamp body, and a lithographically formed mold is used to spin-cast the flexible polymer membrane patterned with the micropillars.

7. The apparatus according to claim 1, wherein the fluid pressure is generated by controlling delivery of a gas or a liquid.

8. The apparatus according to claim 1, wherein the plurality of micropillars is fabricated at a density of substantially 1000 to 2500 pillars/mm².

9. The apparatus according to claim 1, wherein each of the micropillars terminates with a simple square end or expanded end having a substantially flat end face.

10. A micro-stamp pick-and-place method comprising:
using a 3D printed mold and a first elastomer to cast a micro-bubble stamp body with a hollow micro-cavity and a fluidic channel;
using a lithographically formed mold and a second elastomer solution to spin-cast a flexible membrane patterned with micropillars;
bonding the flexible membrane with micropillars onto the micro-bubble stamp body to produce a micro-stamp pick-and-place device;
supporting the micro-stamp pick-and-place device with an XYZ stage;
fluidly connecting the fluidic channel to a fluid control valve; and
connecting a pump and a controller to operate the XYZ stage and the fluid control valve to actuate a micro-stamp pick-and-place device to handle workpieces of die(s) or chip(s).

11. The method according to claim 10, further comprising:
assembling an array of the micro-stamp pick-and-place devices; and
connecting groups of the micro-stamp pick-and-place devices to separate fluidic channels, so that the array of micro-stamp pick-and-place devices are operable in groups.

12. The method according to claim 11, wherein groupings of the micro-stamp pick-and-place devices correspond with desired patterns of picking or placing of the workpieces.
